(19) United States
(12) Patent Application Publication
(10) Pub. No.: US 2026/0013698 A1
(43) Pub. Date: Jan. 15, 2026

(54) TROLLEY AND CONTAINER SYSTEM

(71) Applicant: The Libman Company, Arcola, IL (US)

(72) Inventors: Andrew D. Libman, Champaign, IL (US); Dezso F. Csoka, Cary, IL (US)

(21) Appl. No.: 18/768,489

(22) Filed: Jul. 10, 2024

(51) Int. Cl. A47L 13/51; B62B 3/04; B62B 3/12

(52) U.S. Cl. CPC A47L 13/51; B62B 3/04; B62B 3/12

(57) ABSTRACT

A container and trolley system comprises a container that has a base and a sidewall that form a cavity and a trolley that comprises a trolley base and a plurality of wheels. The trolley base may include a container receiver that has a bottom surface that supports the container and sidewall surface. A projection may extend from the sidewall surface that has a proximal end at the sidewall surface and a distal end that extends toward a central region of the container receiver. The projection may engage the container to help secure the container to the trolley.

### FIELD OF THE INVENTION

This disclosure relates to a movable trolley that supports and secures a container.

### BACKGROUND

When using a container, like a bucket, the ability to easily move the container can improve a user’s experience and efficiency with the container. The ease of movement of the container may be particularly helpful when using the container for mopping or cleaning.

### BRIEF SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

This disclosure may relate to a trolley that is configured to secure a container comprising: (a) a trolley body that includes a side structure having a lower end and an upper end, an upper surface extending from the upper end of the side structure, and a lower surface opposite the upper surface, where the upper surface comprises a container receiver; and (b) a plurality of wheel assemblies connected to a plurality of wheel receivers connected to the lower surface of the trolley body. The container receiver may include a bottom surface spaced below the upper surface and a sidewall surface extending between the upper surface and the bottom surface. The sidewall surface may also include a first projection, where the first projection has a proximal end and a distal end opposite the proximal end. The proximal end may be connected to the sidewall surface, and the distal end may be located a first predetermined distance from the sidewall surface in a direction toward a central region of the container receiver. The sidewall surface may include a second projection, where the second projection has a proximal end and a distal end opposite the proximal end. The proximal end of the second projection may be connected to the sidewall surface, and the distal end of the second projection may be located a second predetermined distance from the sidewall surface in a direction toward the central region of the container receiver. In some examples, the first predetermined distance is the same as the second predetermined distance. A centerline of the first projection may be substantially aligned with a centerline of the second projection. In addition, the distal end of the first projection may have a rounded shape. The first projection may have a rounded upper surface. The plurality of wheel receivers may comprise a first pair of wheel receivers and a second pair of wheel receivers, where the first pair of wheel receivers are connected by a first rib and the second pair of wheel receivers are connected by a second rib. The first rib and the second rib may intersect each other. In some instance, the first rib and the second rib may intersect each other at an intersection point that is aligned with a centerline of the first projection. The sidewall surface may comprise a first portion, a second portion opposite the first portion, a third portion that extends between the first portion and the second portion, and a fourth portion that is opposite the third portion, where the third portion extends between the first portion and the second portion. The third portion may include a first region with a first curvature and a second region with a second curvature, where the second region forms a recess within the third portion. The trolley body may have a mass within a range of .9 kg and 1.1 kg. The sidewall surface may include a first pocket that is adjacent a proximal end of the first projection, where the sidewall surface may include a second pocket that is adjacent the proximal end of the first projection. The second pocket may be opposite the first pocket.

Other aspects of this disclosure may relate to a container and trolley system comprising: (a) a container that includes a base and a sidewall extending upward from the base forming a cavity with an opening at a top end of the sidewall, and (b) a trolley comprising: (1) a trolley body that includes a side structure having a lower end and an upper end, an upper surface extending from the upper end of the side structure, and a lower surface opposite the upper surface, where the upper surface comprises a container receiver, and (2) a plurality of wheel assemblies connected to a plurality of wheel receivers connected to the lower surface of the trolley body. The container receiver may include a bottom surface spaced below the upper surface and a sidewall surface extending between the upper surface and the bottom surface. The sidewall surface may include a first projection extending inward from the sidewall surface. The first projection may also be connected to the bottom surface of the container receiver. The bottom surface of the container receiver may support the base of the container and the first projection may engage the container to help secure the container to the trolley. In some examples, the first projection may contact the sidewall of the container. In addition, the sidewall surface of the trolley body may further include a second projection that is opposite the first projection, where the second projection also engages the container to help secure the container to the trolley body. The second projection may contact the sidewall of the container. The container may further comprise a divider wall connected to the sidewall, where the divider wall divides the cavity into a pair of compartments. The base of the container may include a first recess, where the first projection can be received in the first recess. The sidewall surface of the trolley body may further include a second projection that is opposite the first projection, and the base of the container may include a second recess, where the second projection is received in the second recess. The sidewall surface may comprise a first portion, a second portion opposite the first portion, a third portion that extends between the first portion and the second portion, and a fourth portion that is opposite the third portion, where the third portion extends between the first portion and the second portion. The third portion may include a first region with a first curvature and a second region with a second curvature, where the second region forms a recess within the third portion. The first projection may have a proximal end located on the second region of the third portion of the sidewall surface. The first projection may have a distal end spaced inward from the sidewall surface, where the distal end of the first projection has a rounded shape, and where the first projection has a rounded upper surface.

### BRIEF DESCRIPTION OF THE DRAWINGS

FIG. 1 depicts a top, left, front perspective view of an exemplary container and trolley system according to aspects disclosed herein;

FIG. 2 depicts a top, front perspective view of the container and trolley system of FIG. 1 according to aspects disclosed herein;

FIG. 3 depicts a top, left, front perspective view of an alternate exemplary container and trolley system according to aspects disclosed herein;

FIG. 4 depicts a top, right, front perspective view of the container and trolley system of FIG. 3 according to aspects disclosed herein;

FIG. 5 depicts a top, right, front perspective view of an exemplary trolley body of an exemplary trolley of the trolley systems of FIGS. 1 and 3 according to aspects disclosed herein;

FIG. 6 depicts a top view of the trolley body of FIG. 5 according to aspects disclosed herein;

FIG. 7 depicts a bottom view of the trolley body of FIG. 5 according to aspects disclosed herein;

FIG. 8 depicts a front view of the trolley body of FIG. 5 according to aspects disclosed herein;

FIG. 9 depicts a side view of the trolley body of FIG. 5 according to aspects disclosed herein;

FIG. 10 depicts a partial view of FIG. 6 according to aspects disclosed herein;

FIG. 11 depicts a partial view of FIG. 6 according to aspects disclosed herein; and

FIG. 12 depicts a partial perspective view of the trolley body of FIG. 5 according to aspects disclosed herein.

### DETAILED DESCRIPTION

In the following description of various example structures, reference is made to the accompanying drawings, which form a part hereof, and in which are shown by way of illustration various example devices, systems, and environments in which aspects may be practiced. It is to be understood that other specific arrangements of parts, example devices, systems, and environments may be utilized and structural and functional modifications may be made without departing from the scope of the present disclosure. Nothing in this specification should be construed as requiring a specific three dimensional orientation of structures in order to fall within the scope of this disclosure. The reader is advised that the attached drawings are not necessarily drawn to scale. When the same reference number appears in more than one drawing, that reference number is used consistently in this specification and the drawings refer to the same or similar parts throughout.

Also, while the terms "top," "bottom," "front," "side," and the like may be used in this specification to describe various example features and elements of the disclosed portably containers, these terms are used herein as a matter of convenience, e.g., based on the example orientations shown in the figures or the orientation during typical use. Additionally, the term "plurality," as used herein, indicates any number greater than one, either disjunctively or conjunctively, as necessary, up to an infinite number.

The term “connect,” as used herein indicates that components, surfaces, or features and the like may be directly or indirectly (i.e. through an intermediary) joined, linked or attached.

As used herein, the term “substantially” means mostly, or almost the same as, within the constraints of sensible commercial engineering objectives, costs, manufacturing tolerances, and capabilities in the field of manufacturing the article being formed.

In general, aspects of this disclosure relate to a trolley and container system where a trolley may support a container to easily move and transport the container and its contents. According to various aspects and examples, the container and the trolley may be formed of one or more of a variety of materials, such as metals (including metal alloys), polymers, and composites, and may be formed in one of a variety of configurations, without departing from the scope of this disclosure. It is understood that the containers may contain components made of several different materials. Additionally, the components may be formed by various forming methods. For example, metal components, may be formed by forging, molding, casting, stamping, machining, and/or other known techniques. Additionally, polymer components may be manufactured by polymer processing techniques, such as various molding and casting techniques and/or other known techniques.

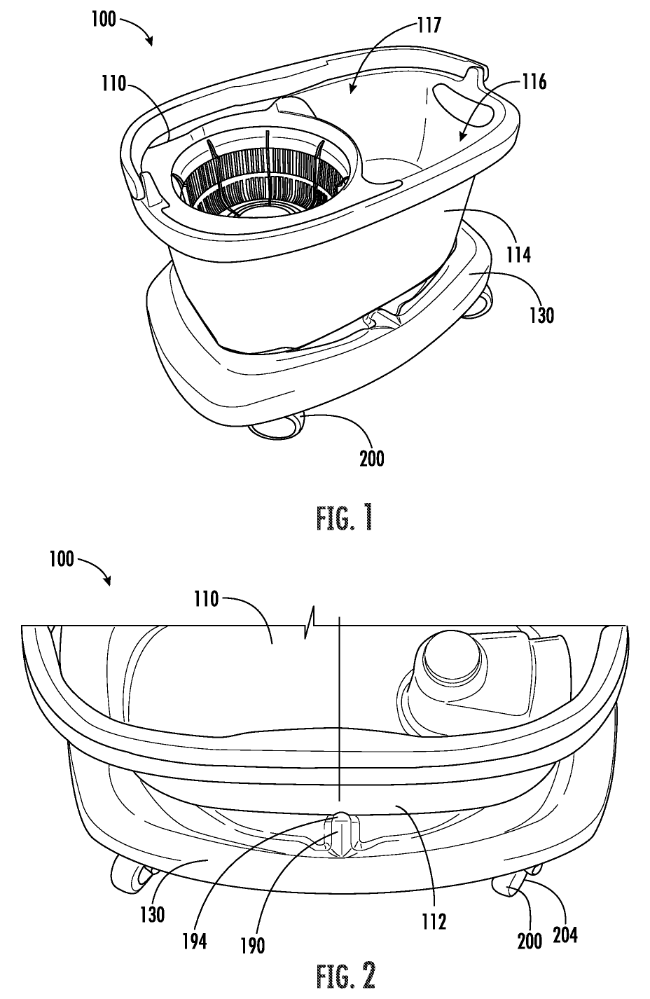

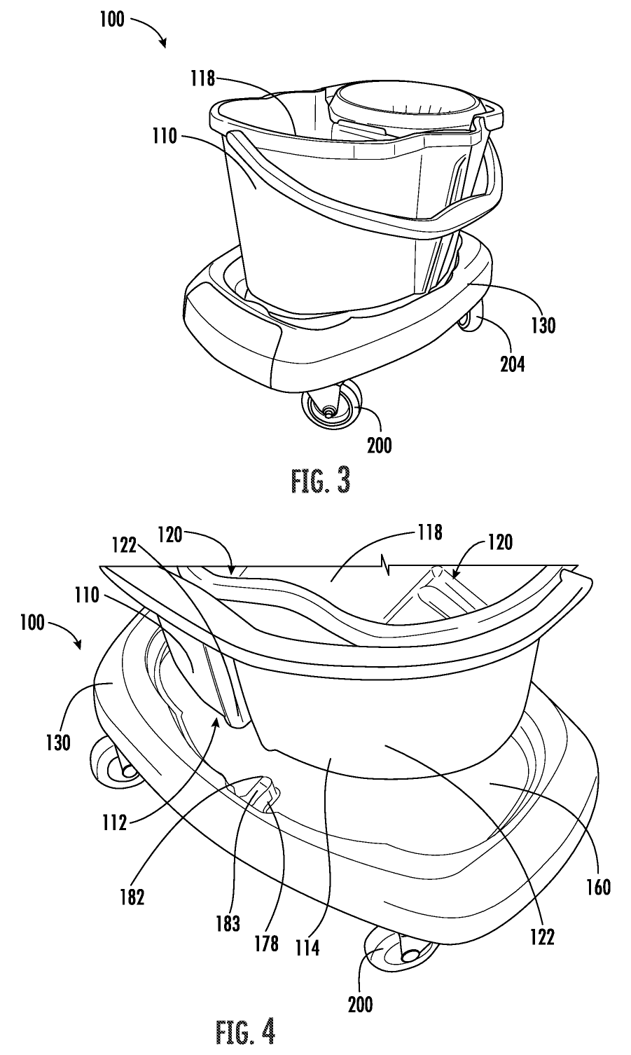

FIGS. 1-4 depict exemplary trolley and container systems 100. The trolley and container system 100 may comprise container 110 and trolley 130. The trolley 130 may be configured to support and secure containers 110 of different sizes. For instance, FIGS. 1-2 illustrate the trolley 130 supporting container 110, while FIGS. 3-4 illustrate the trolley 130 supporting an alternate container 110 with a different shape than container 110 of FIGS. 1-2. As discussed in more detail below, the trolley 130 may include features to both support and secure the container 110 to allow it to be easily moved along a surface such as a floor. The trolley 130 may include a trolley body 140 and a plurality of wheel assemblies 200 that extend below the trolley body 140 to support the trolley body 140 and to allow the trolley 130 to be easily moved along a surface.

As shown in FIGS. 1-4, the trolley and container system 100 may comprise a container 110 that includes a base 112 and a sidewall 114 that extends upward from the base 112 forming a cavity 116 with an opening 117 at a top end of the sidewall 114. The cavity 116 may be configured to hold a liquid. A divider wall 118 may be connected to the sidewall 114 such that the divider wall 118 divides the cavity 116 into a pair of storage compartments 120. Each storage compartment 120 may be configured to hold a liquid. While some containers 110 may include a smooth base 112 and sidewall 114 (i.e., free of projections or recesses), other containers 110, as shown in FIGS. 3 and 4, may include a recess 122 that may be positioned in the base 112 adjacent to or even within the divider wall 118. In the illustrated example of FIGS. 3 and 4, the recess 122 extends through the sidewall 114. In some instances, the container 110 may be a bucket that is used to hold a liquid for a mop or other cleaning implement.

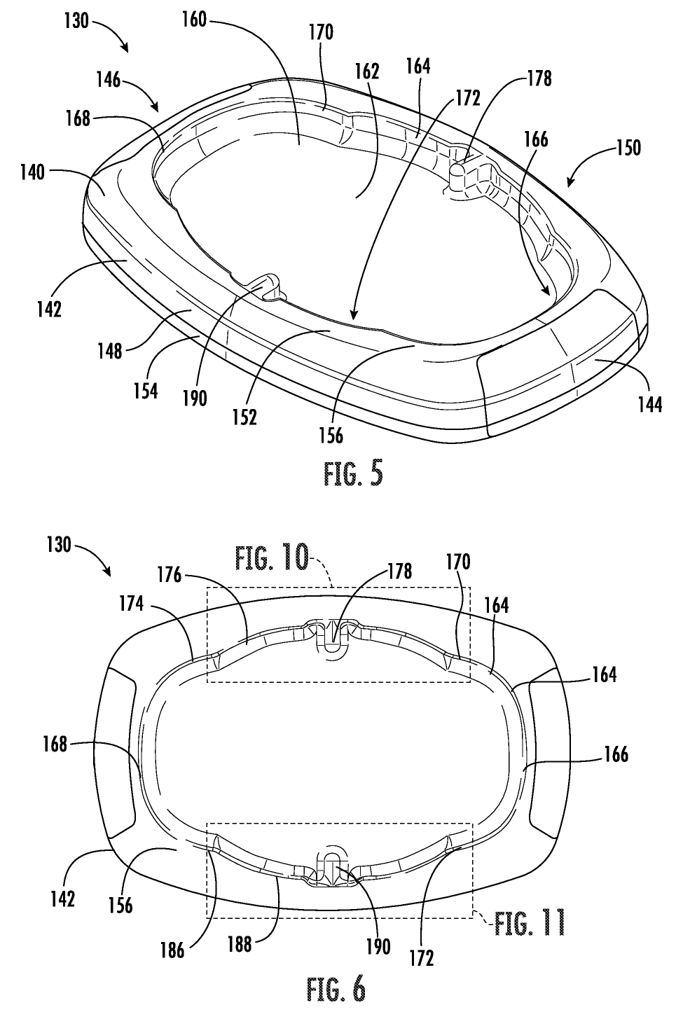

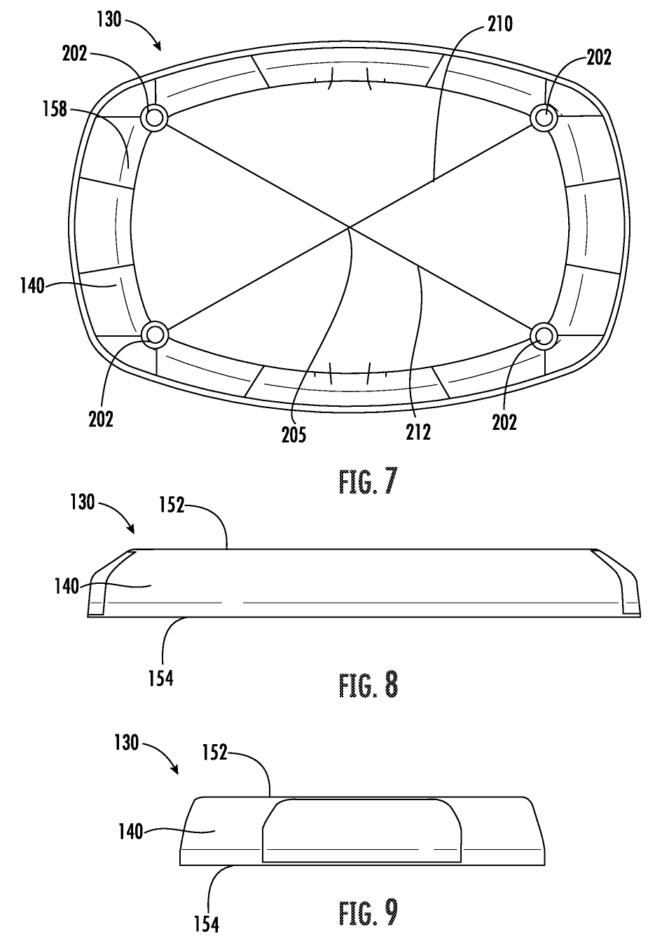

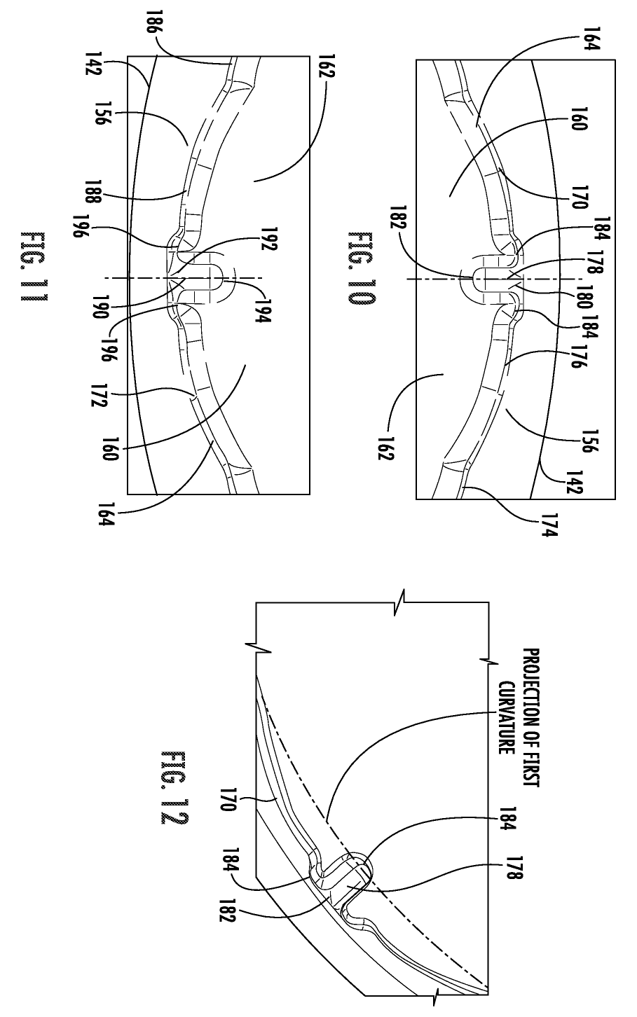

As best shown in FIGS. 5-12, the trolley 130 may be configured to support and secure a container 110. The trolley 130 may comprise a trolley body 140, where the trolley body 140 may include a side structure 142 that comprises a first side 144, a second side 146 opposite the first side 144, a third side 148 extending between the first side 144 and the second side 146, and a fourth side 150 opposite the third side 148. The side structure 142 may also have an upper end 152 and a lower end 154. The trolley body 140 may include an upper surface 156 that connects to the upper end 152 of the side structure 142. The upper surface 156 may connect to the first side 144, the second side 146, the third side 148, and the fourth side 150. The first side 144, the second side 146, the third side 148, and the fourth side 150 may be convex surfaces.

The upper surface 156 may comprise a container receiver 160, where the container receiver 160 includes a bottom surface 162 that is spaced below the upper surface 156 and a sidewall surface 164 that extends between the upper surface 156 and the bottom surface 162. The bottom surface 162 may be substantially planar and be configured to support the container 110. The bottom surface 162 may be spaced a predetermined distance below the upper surface 156. In some examples, the predetermined distance may be approximately 28 mm or within a range of 24 mm and 32 mm. The predetermined distance that the bottom surface 162 of the container receiver 160 is spaced below the upper surface may be expressed as a percentage of an overall height of the trolley body 140, where the overall height is a vertical distance between the upper end 152 and the lower end 154 of the trolley body 140. Thus, the predetermined distance may be approximately 44 percent of the overall height of the trolley body 140, or within a range of 40 percent and 60 percent of the overall height of the trolley body 140. The predetermined distance may help determine the depth of the container receiver 160. The depth of the container receiver 160 may help to stabilize the container 110 to allow the overall center of gravity of the container 110 and trolley 130 system at an optimal location to avoid any tipping or instability when the trolley 130 is moving.

The sidewall surface 164 may comprise a first portion 166, a second portion 168 opposite the first portion 166, a third portion 170 that extends between the first portion 166 and the second portion 168, and a fourth portion 172 that is opposite the third portion 170 and also extends between the first portion 166 and the second portion 168.

The third portion 170 may include a first region 174 with a first curvature and a second region 176 with a second curvature. The second region 176 may be centrally located on the third portion 170 of the sidewall surface 164. The second region 176 may form a recess within the sidewall surface 164. In addition, the second region 176 may include a projection 178 extending upward from the bottom surface 162 and inward from a center of the second region 176 of the sidewall surface 164 toward a central region of the container receiver 160. The first projection 178 may have a proximal end 180 connected to second region of the sidewall surface 164 and a distal end 182 opposite the proximal end 180. The distal end may be located a predetermined distance from the sidewall surface 164 in an inboard direction toward a central region of the container receiver 160. A pocket 184 may be located within the second region 176 of the sidewall surface 164 on either side or both sides of the first projection 178 at the proximal end 180. The first projection 178 may have a centerline that aligns with a midpoint of the third portion 170. The first projection 178 may extend a predetermined amount such that the distal end 182 of the first projection 178 may align with the first curvature of the first region 174 as shown in FIG. 12 when the first curvature is projected along a full length of the third portion 170.

Similar to the third portion 170, the fourth portion 172 may include a first region 186 with a first curvature and a second region 188 with a second curvature. The second region 188 may be centrally located on the fourth portion 172 of the sidewall surface 164. The second region 188 may form a recess within the sidewall surface 164. Additionally, the second region 188 may include a second projection 190 extending upward from the bottom surface 162 and inward from a center of the second region 188. The second projection 190 may have a proximal end 192 connected to second region of the sidewall surface 164 and a distal end 194 opposite the proximal end 192, where the distal end 194 is located inward from the sidewall surface 164. A pocket 196 located within the second region 188 of the sidewall surface 164 may be located on either side or both sides of the projection 190 at the proximal end 192. The second projection 190 may have a centerline that aligns with a midpoint of the fourth portion 172. The second projection 190 may extend a predetermined amount such that the distal end 182 of the second projection 190 may align with the first curvature of the first region 186 when the first curvature is projected along a full length of the fourth portion 172 similar to the first projection 178. The first curvature of the first region 174 of the third portion 170 may be the same as the first curvature of the first region 186 of the fourth portion 172. Similarly, the second curvature of the second region 176 of the third portion 170 may have the same curvature as the second curvature of the second region 188 of the fourth portion 172. Alternatively, the first curvatures of the first region 174 and the first region 186 may be different, and the second curvatures of the second region 176 and the second region 188 may be different.

The first projection 178 and the second projection 190 may be substantially aligned, where a centerline of each projection 178, 190 are aligned. The projections 178, 190 may also include a rounded or tapered upper surface 183, 195 that may be configured to be received within a recess 122 of a container 110. For example, as shown in FIG. 4, one of the projections 178, 190 may be received within a recess 122 of the container 110. In addition, the pockets 184 may receive a portion of the sidewall 114 on containers 110 that have an irregular shaped sidewall or where the sidewall 114 includes protrusions along the sidewall 114.

When the container 110 is engaged with the trolley 130, the base 112 of the container 110 may be received in the container receiver 160 such that the bottom surface 162 supports the base 112 of the container 110. The first projection 178 engages the container 110 to help secure the container 110 to the trolley 130. In some examples, such as the illustrated examples of FIGS. 1 and 2, the distal end 182 of the first projection 178 may contact the sidewall 114 of the container 110 to help secure the container 110. Additionally, the distal end 194 of the second projection 190 may also contact the sidewall 114 of the container 110 such that both projections 178, 190 contact opposite portions of the sidewall 114. In addition, the distal ends 182, 194 may have a rounded shape maybe configured to contact a sidewall 114 of a container, such as container 110 such that the contact area is minimized to allow the container 110 to be slid into the container receiver 160 and not be hindered as it slides along the distal ends 182, 194 of the projections 178, 190.

In other instances, such as the illustrated examples of FIGS. 3 and 4, the first projection 178 of the trolley 130 may be received within the recess 122 to help secure the container 110 to the trolley 130. The second projection 190 may also be received within the recess 122 to further secure the container 110 to the trolley 130. In some examples, the container 110 may have a plurality of recesses 122 where each recess 122 is configured to receive a projection 178 or 190 of the trolley 130. The engagement of the container receiver 160 and the projections 178, 190 with the container 110 may help to prevent the container 110 from tipping or vibrating when connected to the trolley 130. This will allow a user to place a mop or other cleaning implement within the cavity 116 and not have the container 110 come loose from the trolley 130, while the trolley 130 provides a simple means for a user to move the container 110.

The container 110 may be constructed from one or more metals, alloys, polymers, ceramics, or fiber-reinforced materials. Additionally, container 110 may be constructed using one or more molding techniques. In one implementation, the container 110 may include a handle or other accessories to make the container 110 easier to lift by a user. In some examples, a wringer or wringer basket may be located in the cavity 116 or in some instances, one of the storage compartments 120. In some examples, the container 110 may be embodied with different geometries. For example, the container 110 may have a substantially oval or non-cylindrical shape. Alternatively, the container 110 may have a substantially cuboidal shape or may have protrusions on the sides or ends that extend beyond a perimeter profile of the base 112.

As shown in FIG. 7, a plurality of wheel receivers 202 may extend from a lower surface 158 of the trolley body 140, where each wheel receiver 202 may receive and secure a wheel assembly 200 to the trolley body 140. Each wheel assembly 200 may have a vertical axle that engages its corresponding wheel receiver 202. Each wheel 204 may rotate around a horizontal axle that connects the wheel 204 to a wheel housing. In some examples, each wheel 204 may have a diameter that is less than the overall height of the trolley body 140. The wheel assembly 200 may be free to rotate 360 degrees around the vertical axle and the corresponding wheel receiver 202. The plurality of wheel receivers 202 may comprise 4 receivers, where a first pair of wheel receivers 202 may be connected by a first rib 210 that extends from the lower surface 158 of the trolley body 140 and contacts an external surface of the wheel receiver 202. A second pair of wheel receivers 202 may be connected by a second rib 212 that also extends from the lower surface 158 of the trolley body 140 that contacts an external surface of each wheel receiver 202 of the second pair of wheel receivers 202. In some instances, one or more of the wheel assemblies 200 may include a braking element to prevent rotation of one of the wheels 204 and prevent inadvertent movement of the trolley 130. The first rib 210 and the second rib 212 may contact each other at an intersection point 205 located at a central region of the container receiver 160. The centerline of the projection 178 and the centerline of the projection 190 may be substantially aligned with the intersection point 205 where the ribs 210, 212 intersect. The rib structure helps to provide stiffness between the wheel receivers 202 and the help support the bottom surface 162 of the container receiver 160.

In some examples, the overall mass of the trolley body 140 may be approximately 1 kilogram (kg), or may be within a range of 0.9 kg and 1.1 kg. The overall mass of the trolley 130 may be less than 1.5 kg. In addition, the center of gravity of the trolley 130 may be located a center of the container receiver 160 (i.e., the center of gravity is substantially aligned in a horizontal and longitudinal direction with intersection point 205 of the ribs 210, 212). By keeping the weight below 1.5 kg and the center of gravity centrally located, the trolley 130 may be easily movable by a user. In addition, by keeping the trolley mass below 1.5 kg, the trolley 130 will not be inhibit movement of the trolley 130 when supporting the container 110.

The present disclosure is disclosed above and in the accompanying drawings with reference to a variety of examples. The various dimensions described above are merely exemplary and may be changed as necessary. Accordingly, it will be apparent to those of ordinary skill in the art that many more embodiments and implementations are possible that are within the scope of the claims. Therefore, the embodiments described are only provided to aid in understanding the claims and do not limit the scope of the claims.

We claim:

1. A trolley configured to secure a container comprising:
a trolley body comprising a side structure having a lower end and an upper end, an upper surface extending from the upper end of the side structure, and a lower surface opposite the upper surface, wherein the upper surface comprises a container receiver;
wherein the container receiver includes a bottom surface spaced below the upper surface and a sidewall surface extending between the upper surface and the bottom surface;
wherein the sidewall surface includes a first projection;
wherein the first projection has a proximal end and a distal end opposite the proximal end, wherein the proximal end is connected to the sidewall surface and the distal end is located a first predetermined distance from the sidewall surface in a direction toward a central region of the container receiver; and
a plurality of wheel assemblies connected to a plurality of wheel receivers connected to the lower surface of the trolley body.

2. The trolley of claim 1, wherein the sidewall surface includes a second projection, wherein the second projection has a proximal end and a distal end opposite the proximal end, wherein the proximal end is connected to the sidewall surface and the distal end is located a second predetermined distance from the sidewall surface in a direction toward the central region of the container receiver; and
wherein the first predetermined distance is the same as the second predetermined distance.

3. The trolley of claim 2, wherein a centerline of the first projection is substantially aligned with a centerline of the second projection.

4. The trolley of claim 1, wherein the distal end of the first projection has a rounded shape.

5. The trolley of claim 1, wherein the first projection has a rounded upper surface.

6. The trolley of claim 1, wherein the plurality of wheel receivers comprises a first pair of wheel receivers and a second pair of wheel receivers, wherein the first pair of wheel receivers are connected by a first rib and the second pair of wheel receivers are connected by a second rib, wherein the first rib and the second rib intersect each other.

7. The trolley of claim 6, wherein the first rib and the second rib intersect at an intersection point that is aligned with a centerline of the first projection.

8. The trolley of claim 1,
wherein the sidewall surface comprises a first portion, a second portion opposite the first portion, a third portion that extends between the first portion and the second portion, and a fourth portion that is opposite the third portion, wherein the third portion extends between the first portion and the second portion; and
wherein the third portion includes a first region with a first curvature and a second region with a second curvature, wherein the second region forms a recess within the third portion.

9. The trolley of claim 1, wherein a mass of the trolley body is within a range of .9 kg and 1.1 kg.

10. The trolley of claim 1, wherein the sidewall surface includes a first pocket that is adjacent the proximal end of the first projection.

11. The trolley of claim 10, wherein the sidewall surface includes a second pocket that is adjacent the proximal end of the first projection, wherein the second pocket is opposite the first pocket.

12. A container and trolley system comprising:
the container comprising a base and a sidewall extending upward from the base forming a cavity with an opening at a top end of the sidewall; and
a trolley comprising:
a trolley body comprising a side structure having a lower end and an upper end, an upper surface extending from the upper end of the side structure, and a lower surface opposite the upper surface, wherein the upper surface comprises a container receiver;
wherein the container receiver includes a bottom surface spaced below the upper surface and a sidewall surface extending between the upper surface and the bottom surface;
wherein the sidewall surface includes a first projection extending inward from the sidewall surface and wherein the first projection is connected to the bottom surface of the container receiver; and
a plurality of wheel assemblies connected to a plurality of wheel receivers connected to the lower surface of the trolley body; and
wherein the bottom surface of the container receiver supports the base of the container and the first projection engages the container to help secure the container to the trolley.

13. The container and trolley system of claim 12, wherein the first projection contacts the sidewall of the container.

14. The container and trolley system of claim 13, wherein the sidewall surface of the trolley body further includes a second projection that is opposite the first projection, and wherein the second projection also engages the container to help secure the container to the trolley body.

15. The container and trolley system of claim 14, wherein the second projection contacts the sidewall of the container.

16. The container and trolley system of claim 12, wherein the container further comprises a divider wall connected to the sidewall, wherein the divider wall divides the cavity into a pair of compartments, and wherein the base of the container includes a first recess, and wherein the first projection is received in the first recess.

17. The container and trolley system of claim 16,
wherein the sidewall surface of the trolley body further includes a second projection that is opposite the first projection, and
wherein the base of the container includes a second recess, and wherein the second projection is received in the second recess.

18. The container and trolley system of claim 12,
wherein the sidewall surface comprises a first portion, a second portion opposite the first portion, a third portion that extends between the first portion and the second portion, and a fourth portion that is opposite the third portion, wherein the third portion extends between the first portion and the second portion; and
wherein the third portion includes a first region with a first curvature and a second region with a second curvature, wherein the second region forms a recess within the third portion.

19. The container and trolley system of claim 18, wherein the first projection has a proximal end located on the second region.

20. The container and trolley system of claim 12, wherein the first projection has a distal end spaced inward from the sidewall surface, wherein the distal end of the first projection has a rounded shape, and wherein the first projection has a rounded upper surface.
